(19) United States
(12) Patent Application Publication
(10) Pub. No.: US 2020/0001256 A1
(43) Pub. Date: Jan. 2, 2020

(54) METHOD OF PRODUCING A PRODUCT HAVING MIXED CONSTITUENTS AND MIXING APPARATUS

(71) Applicant: Eirich Machines, Inc., Gurnee, IL (US)

(72) Inventors: AUDERIO DINO CHECE, Des Plaines, IL (US); ORLANDO RODRIGUEZ, Chicago, IL (US)

(21) Appl. No.: 16/024,010

(22) Filed: Jun. 29, 2018

(51) Int. Cl. B01F 9/08; B01F 7/00; B01F 15/00; B01F 15/06

(52) U.S. Cl. CPC B01F 9/08; B01F 7/00425; B01F 7/00125; B02C 23/20; B01F 15/00538; B01F 15/068; B01F 15/00675

(57) ABSTRACT

According to one aspect, a method of producing a product having mixed constituents comprises the step of providing a mixing apparatus including a main housing having an inlet and an outlet opposite the inlet wherein the outlet is disposed at a lower portion of the main housing, a mixing drum disposed in the main housing wherein the mixing drum includes an opening that is movable between a first position aligned with the inlet and a second position aligned with the outlet, and an agitator disposed inside the mixing drum. The method further includes the step of providing first and second materials, positioning the mixing drum at the first position, and introducing the first and second materials into the mixing drum through the aligned opening and inlet. Still further, the method includes the steps of operating the agitator to mix the first and second materials to produce a human-edible product, moving the mixing drum to the second position, and removing the human-edible product from the mixing drum through the aligned opening and outlet. A mixing apparatus is also disclosed.

### FIELD OF DISCLOSURE

The present subject matter relates to mixing methods and devices, and more particularly to a method of producing a product having mixed constituents and an apparatus that mixes materials and is easy to operate and clean.

### BACKGROUND

Current mixer designs do not fully discharge all material following a mixing operation leading to cross-contamination from one batch to the other and/or loss of product and concomitant loss of revenue. Specifically, existing designs, such as the so-called “bomb bay” door design comprising two hinged doors disposed at the bottom of the mixer that are hinged at laterally spaced outer portions and open in the middle to release mixed product, do not fully discharge product inasmuch as product is usually left at the hinged outer portions of the doors. Also, the discharge mechanism is problematic due to the presence of several moving components at the product discharge area that pose sanitary concerns.

Existing full batch discharge mixers, such as the “dump style” mixer, offer full discharge of material, but such a mixer utilizes a single shell design that requires a pan to tilt and discharge with an open cover. Such a design presents a pinch point when product is discharged that can injure a user. Also, no provision is made for full washdown of the mixer between uses.

### SUMMARY

According to one aspect, a method of producing a product having mixed constituents comprises the step of providing a mixing apparatus including a main housing having an inlet and an outlet opposite the inlet wherein the outlet is disposed at a lower portion of the main housing, a mixing drum disposed in the main housing wherein the mixing drum includes an opening that is movable between a first position aligned with the inlet and a second position aligned with the outlet, and an agitator disposed inside the mixing drum. The method further includes the step of providing first and second materials, positioning the mixing drum at the first position, and introducing the first and second materials into the mixing drum through the aligned opening and inlet. Still further, the method includes the steps of operating the agitator to mix the first and second materials to produce a human-edible product, moving the mixing drum to the second position, and removing the human-edible product from the mixing drum through the aligned opening and outlet

According to another aspect a method of producing a product having mixed constituents includes the step of (a.) providing a mixing apparatus including a main housing having an inlet and an outlet opposite the inlet wherein the outlet is disposed at a lower portion of the main housing, a mixing drum disposed in the main housing wherein the mixing drum includes an opening that is movable between a first position aligned with the inlet and a second position aligned with the outlet, a liquid spraying apparatus, and an agitator disposed inside the mixing drum. The method further includes the steps of (b.) providing a first batch of first and second materials, (c.) positioning the mixing drum at the first position, and (d.) introducing the first and second materials into the mixing drum through the aligned opening and inlet. Still further, the method includes the steps of (e.) operating the agitator to mix the first and second materials to produce a human-edible product, (f.) moving the mixing drum to the second position, (g.) removing the human-edible product from the mixing drum through the aligned opening and outlet, (h.) operating the liquid spraying apparatus to spray a liquid toward at least one of the mixing drum and the outlet, (i.) drying the liquid, (j.) providing a second batch of the first and second materials, and (k) repeating steps (c.)-(i.) for the second batch of the first and second materials.

According to yet another aspect, a mixing apparatus comprises a main housing having an inlet and an outlet opposite the inlet wherein the outlet is disposed at a lower portion of the main housing and a mixing drum disposed in the main housing. The mixing drum is disposed inside the main housing and includes an opening that is movable between a first position aligned with the inlet and second position aligned with the outlet and further has a non-apertured side wall terminating at side edges of the opening. An agitator is disposed inside the mixing drum and a motor moves the mixing drum between the first and second positions.

Other aspects and advantages will become apparent upon consideration of the following detailed description and the attached drawings wherein like numerals designate like structures throughout the specification.

### BRIEF DESCRIPTION OF THE DRAWINGS

FIG. 1 comprises a block diagram of a production system utilizing a mixer as described herein;

FIG. 2 comprises an isometric view of a mixer together with a motor taken from a first side and a top of the mixer;

FIG. 3 comprises an isometric view of the mixer of FIG. 2 together with a motor taken from the first side and a bottom of the mixer;

FIG. 4 is an exploded isometric view of the mixer of FIG. 2 taken from the first side and the top of the mixer;

FIG. 5 is an isometric view of the mixing drum of the mixer of FIG. 2;

FIG. 6 is a flowchart of a method utilizing the mixer of FIG. 2;

FIG. 7 is a fragmentary isometric view of the mixer of FIG. 2 taken from a second side and the top of the mixer of FIG. 2 with an end plate removed therefrom, a side plate shown as transparent to reveal structures behind the side plate, and with an opening of the mixing drum aligned with an inlet of the mixer;

FIG. 8 is a fragmentary isometric view of the mixer of FIG. 2 taken from the second side and the top of the mixer of FIG. 2 with an end plate removed therefrom and with an opening of the mixing drum aligned with an outlet of the mixer;

FIG. 9 is a sectional isometric view taken generally along the lines 9-9 of FIG. 8;

FIG. 10 is an isometric view of an alternative embodiment of a mixer;

FIG. 11 is a side elevational view of the mixer of FIG. 10;

FIG. 12 is a bottom fragmentary isometric view of the mixer of FIG. 10 with portions removed therefrom;

FIG. 13 is a side elevational view of the mixer identical to FIG. 11 with the exception that portions are removed therefrom as in FIG. 12;

FIG. 14 is a top isometric view of the mixer of FIG. 10 with portions removed therefrom;

FIG. 15 is a bottom isometric view of the mixer of FIG. 10 with portions removed therefrom; and

FIG. 16 is a fragmentary sectional view illustrating a further alternative mounting arrangement for the stub shafts and casters.

### DETAILED DESCRIPTION

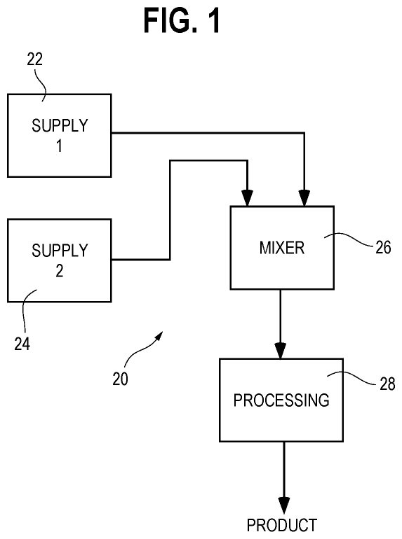

FIG. 1 illustrates a production system 20 that may be used to produce a product having at least two constituents. The system 20 comprises at least first and second supplies 22, 24 of at least first and second materials that are to be combined. A suitable transfer apparatus (not shown) may supply controlled quantities of the first and second materials from the first and second supplies 22, 24 to a mixing apparatus (or mixer) 26 that combines at least the first and second materials to produce a partially or fully mixed combination of constituents forming a product. The product, which may exit the mixer 26 as a single batch, a plurality of portions or sub-batches, a continuous stream, and/or in a discontinuous manner, may comprise an intermediate or final product. The product may optionally be provided to processing apparatus 28 that processes the product in some fashion, such as by changing the particulate size of the product (for example, by agglomerating, comminuting, and/or crushing the product), forming the product into a particular shape or shapes, dividing the product into sub-batches with or without changing the particulate size of the product, combining the product with another product, affecting a physical property of the product (such as heating or cooling the product), packaging the product, and a combination of two or more of such operations. As should be evident from the foregoing, any one or more process(es) may be effected by the apparatus 28.

The present system 20 and the method of use thereof are particularly useful in the production of products that can be safely consumed or used by humans and/or animals owing to the ability (discussed below) to clean the mixer 26 in a simple and effective manner between batches. However, the present system 20 and method of use are not limited to use in the production of edible or human-usable or animal-usable products (including human-edible foods, animal feed, oral and other medicaments, skin products, other personal products, powdered or other detergents, and the like) but can be used in the production of other products.

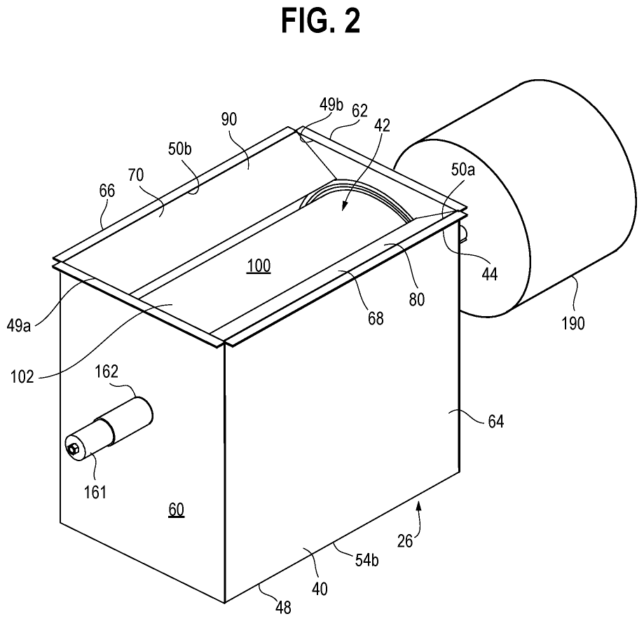

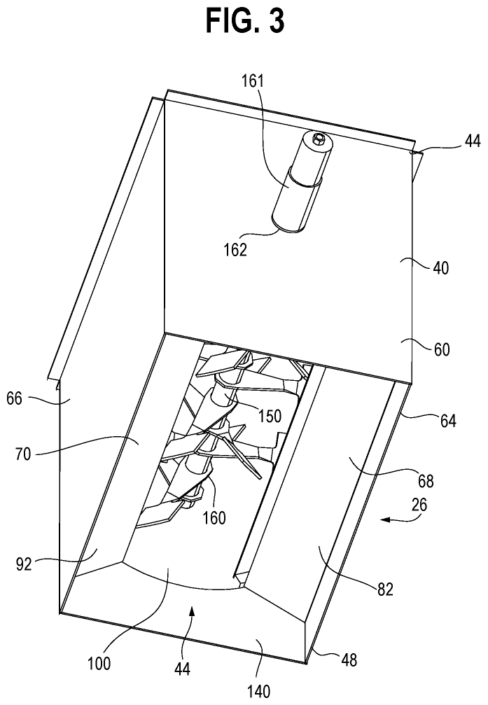

The mixer 26 is illustrated in detail in FIGS. 2-5 and 7-9. The various components of the mixer 26 may be secured together in various suitable ways/devices, such as by welds, brazing, bolts, screws or other fastening devices, or a combination of such ways and/or devices.

With specific reference to FIGS. 2-5 and 7-9, the mixer 26 comprises a main housing 40 having an inlet 42 disposed at a top portion 44 and an outlet 46 disposed at a bottom portion 48 generally or diametrically opposite the inlet 42. The inlet 42 is defined by first and second end edges 49a, 49b, respectively, and first and second side edges 50a, 50b, respectively. In like manner, the outlet 46 is defined by first and second end edges 52a, 52b, respectively, and first and second side edges 54a, 54b, respectively. While the shapes and sizes of the inlet 42 and outlet 46 are illustrated as being similar or identical, it should be noted that this need not be the case, and in fact one or both of the shape and size of the inlet 42 may be different than the shape and/or size of the outlet 46.

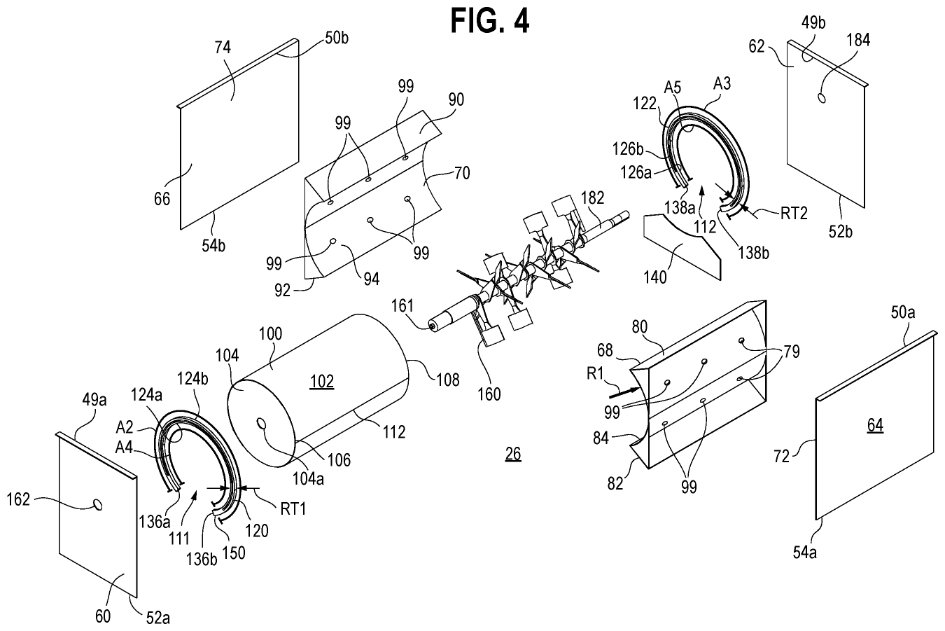

The main housing 40 comprises first and second end plates 60, 62, respectively, and first and second side plates 64, 66, respectively. First and second curved guide plates 68, 70 are carried on inner surfaces 72, 74, respectively, of the first and second side plates 64, 66, respectively, and extend between inner surfaces 76, 78 of the end plates 60, 62. The guide plates 68, 70 are mirror images of one another, and hence, only the guide plate 68 will be described in detail herein. The guide plate 68 comprises an upper ramp portion 80, a lower ramp portion 82, and an arcuate central portion 84 disposed between the ramp portions 80, 82. While each of the ramp portions 80, 82 is shown as being planar, either or both of the portions 80, 82 may have a different shape, such as an arcuate shape, as desired. The central portion 84 preferably has a constant radius of curvature R1 (FIG. 4), at least at portions thereof adjacent the end plates 60, 62.

The guide plate 70 includes upper and lower ramp portions 90, 92, respectively, separated by an arcuate central portion 94 similar or identical to the portions 80, 82, and 84, respectively. The guide plates 68, 70 are separated by a distance measured at axially-extending central lines 96, 98 equal to or slightly larger than twice the radius of curvature R1 and the arcuate central portions 84, 94 are aligned such that the portions 84, 94 together define a circle having a radius substantially or exactly equal to R1.

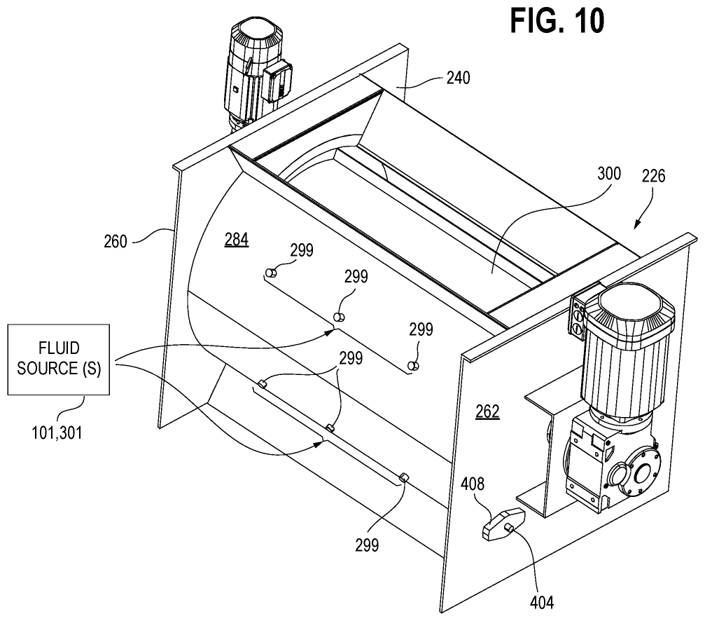

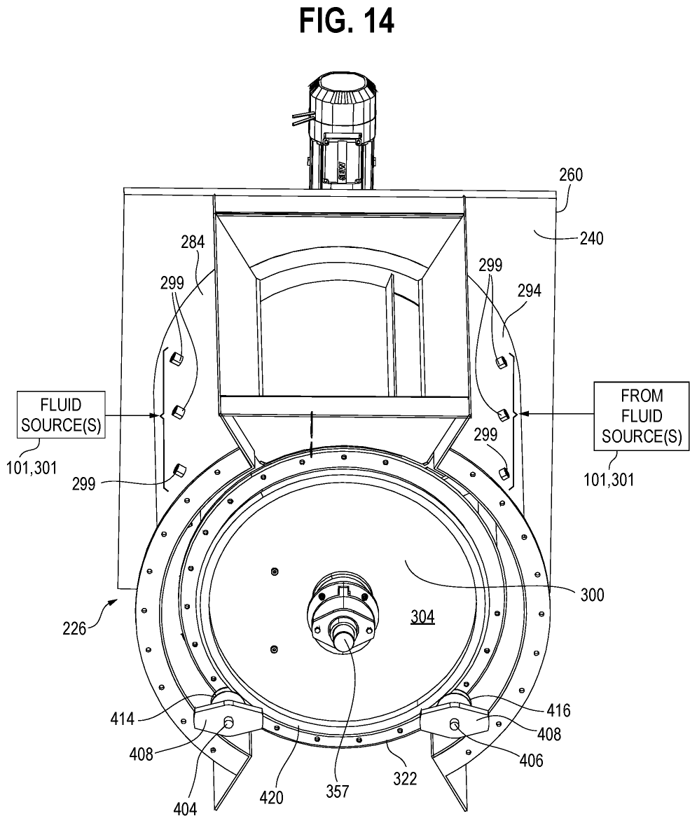

A plurality of fluid dispensing nozzles 99 are carried by and extend through portions of the side plates 64, 66. In the preferred embodiment, the nozzles 99 are mounted in the arcuate central portions 84, 94, although one or more of the nozzles 99 may be mounted in another portion or portions of the main housing 40. The nozzles 99 are coupled to one or more controllable fluid sources, such as a controllable pressurized water and/or a controllable pressurized air source or sources 101 (not shown in FIGS. 2-5 and 7-9, but which are shown in FIGS. 10 and 14).

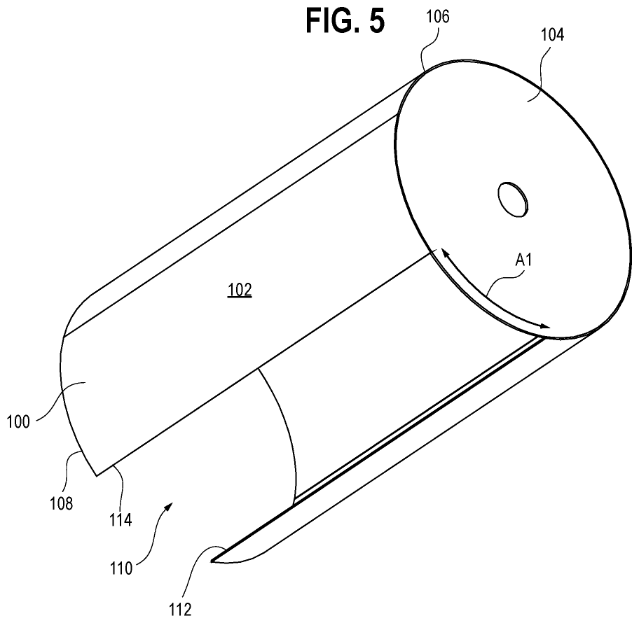

An inner mixing drum 100 comprises a circumferential wall 102 formed into a partial cylinder having a constant radius of curvature R2 and a disk-shaped end wall 104 welded or otherwise secured to a first end 106 of the wall 102. A second end 108 of the wall 102 is left open. Preferably, the wall 102 is non-perforated such that no openings extend therethrough, at least in the portions that contact product being mixed. Also preferably, an opening 110 that extends axially and circumferentially is defined by circumferential ends 112, 114 of the wall 102 and the opening 110 has a circumferential arc length A1 (FIG. 5)

First and second partial rings 120, 122 each defining a partial circle of an arc length A2, A3, respectively, (FIG. 4) are welded or otherwise secured to the first and second ends 106, 108 of the inner mixing drum 100. In the preferred embodiment, A2 and A3 are equal and the partial rings 100, 102 are aligned circumferentially on the mixing drum 100 such that gaps 111, 112 of the partial rings 100, 102, are circumferentially aligned. Still further, each of the partial rings 120, 122 has a constant radial thickness RT1, RT2, respectively, throughout defined by a radial distance between inner and outer circumferential surfaces 124a, 124b and 126a, 126b, respectively. Also, in the preferred embodiment the radial thicknesses RT1 and RT2 are equal.

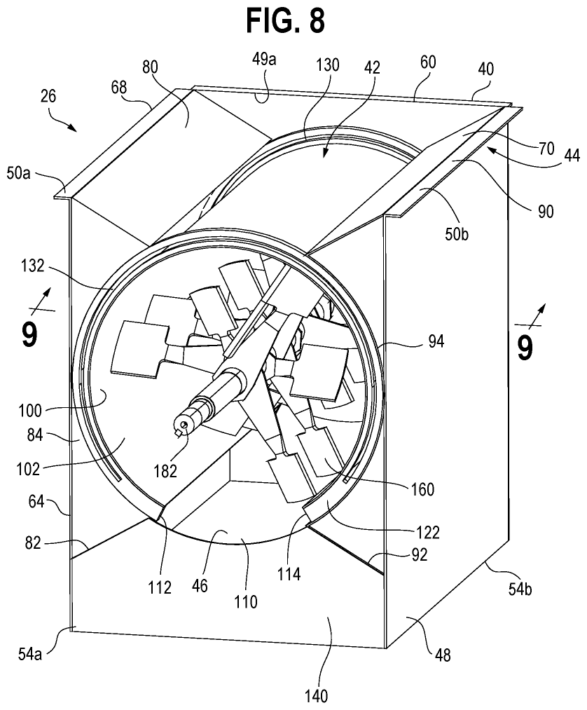

Each of the partial rings 120, 122 includes a circumferential slot 130, 132, respectively, (FIG. 8). In the preferred embodiment, the slots 130 and 132 are of identical dimensions. Specifically, each slot 130, 132 has a radial dimension that is centered between the inner and outer circumferential surfaces 124a, 124b and 126a, 126b, respectively. Each slot 130, 132 further has a circumferential dimension that is centered between circumferential end surfaces 136a, 136b and 138a, 138b, respectively, (FIG. 4). Still further, in the preferred embodiment each slot 130, 132 has an arc length A4, A5. Preferably, one or more ball bearings, casters, or other structures (not shown) are disposed in the slots 130, 132 to facilitate rotation of the mixing drum 100 relative to the main housing 40.

The mixer 26 further includes an apron 140 secured to the inner surface 76 of the of the end plate 60 that assists in supporting the mixing drum 100.

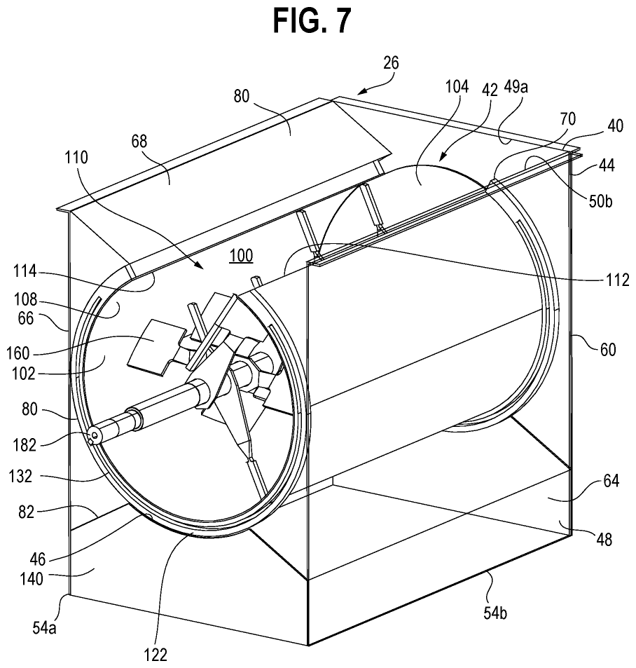

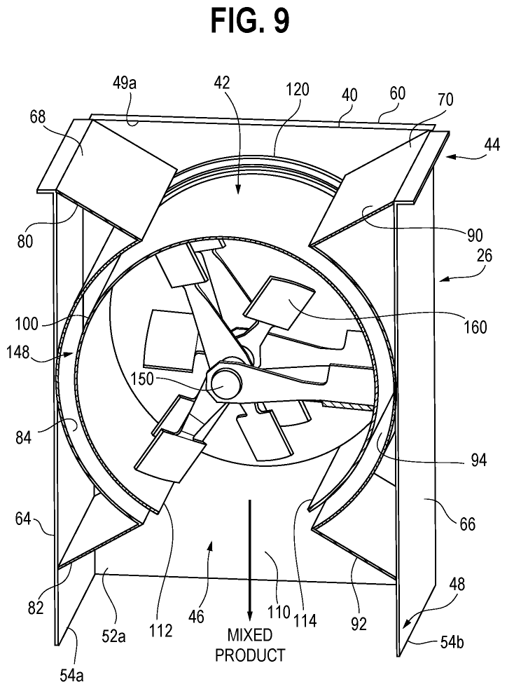

The mixer 26 is assembled by assembling the guide plates 68, 70 to the side plates 64, 66, securing the side plates 64, 66 and, optionally the guide plates 68, 70, to the end plate 62, and securing the apron 140 to edges of the lower ramp portions 82, 92. The mixing drum 100 and the first and second partial rings 120, 122 secured thereto are inserted into the generally cylindrical recess 148 (FIG. 9) defined by the arcuate central portions 84, 94 until the bearings carried in the slot 130 (FIG. 4) of the partial ring 120 contacts the inner surface 76 of the end plate 60. The diameter of the outer circumferential surface 124b of the partial ring 120 is slightly smaller than the circle of radius R1 defined by the arcuate central portions 84, 94. A rotary motor-driven agitator 160 is inserted into the mixing drum 100 through the open end 108 thereof such that a first spindle 161 extends through a bore 104a in the plate 104 (FIG. 4) and an aligned bore 162 in the end plate 60. At this stage, the partially assembled mixer 26 appears as shown in FIG. 7. Of significance is that, even at such assembly stage, the mixing drum 100 is stably supported in the generally cylindrical recess 148 and that the agitator 160 is removable therefrom so that cleaning may be facilitated.

The assembly steps for the mixer 26 are completed by fastening the remaining end plate 62 to the other portions of the mixer 26 such that a second spindle 182 of the agitator 160 extends through a bore 184 (FIG. 4) in the end plate 62 and the bearings in the slot 132 contact an inner surface of the end plate 62. In this regard it is advantageous to have the end plate 62 removably fastened by bolts or other fasteners to the remainder of the mixer 26 so that the end plate 62 is readily removable to permit servicing and/or cleaning of the various components.

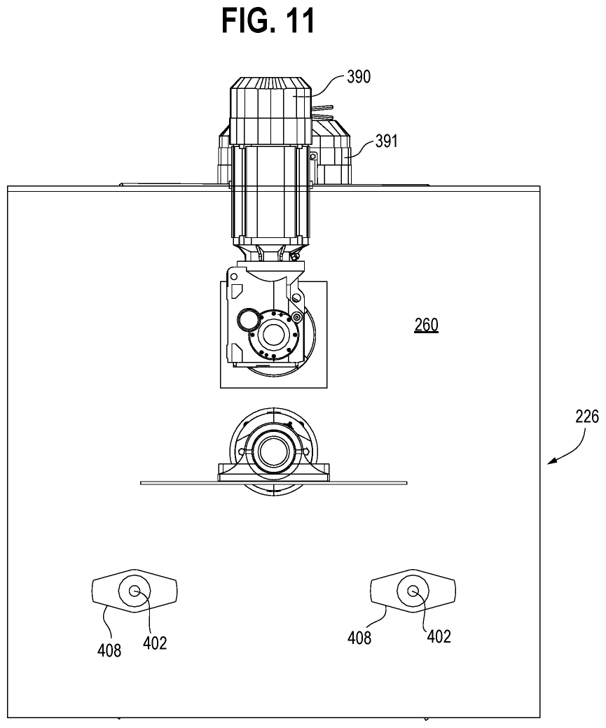

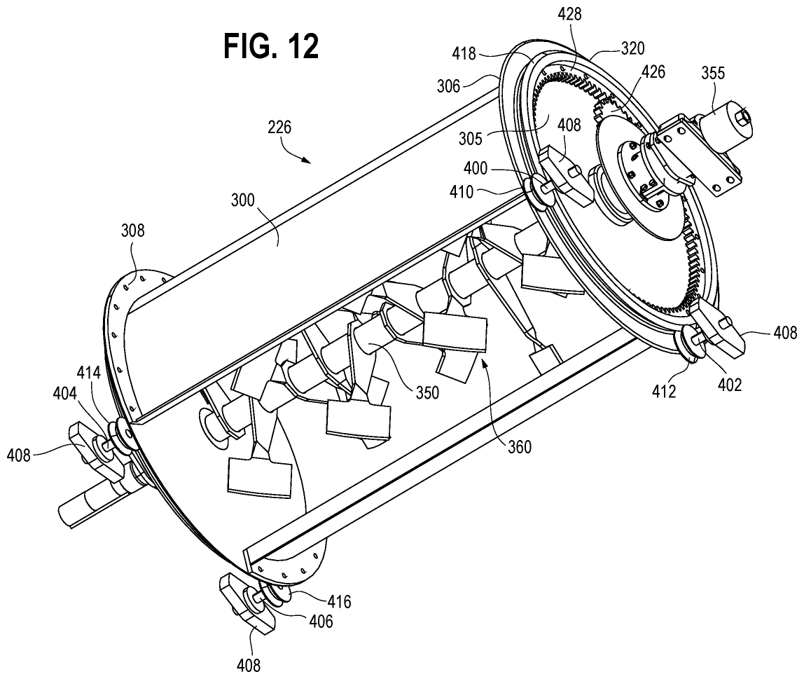

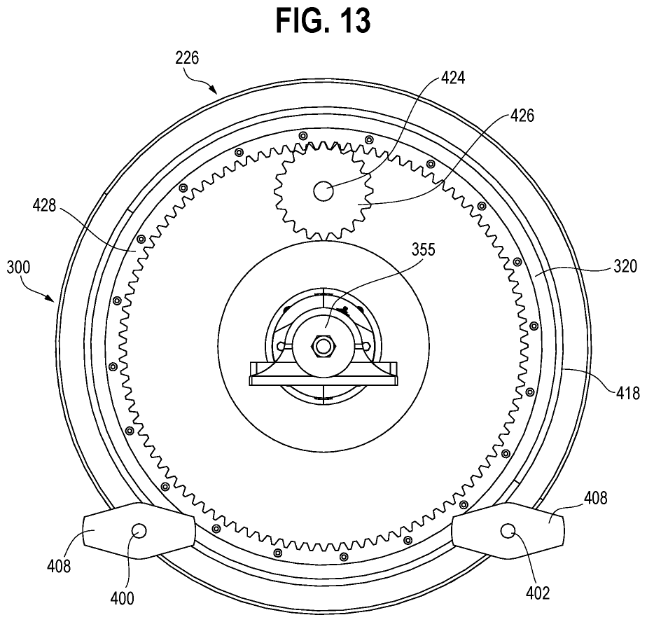

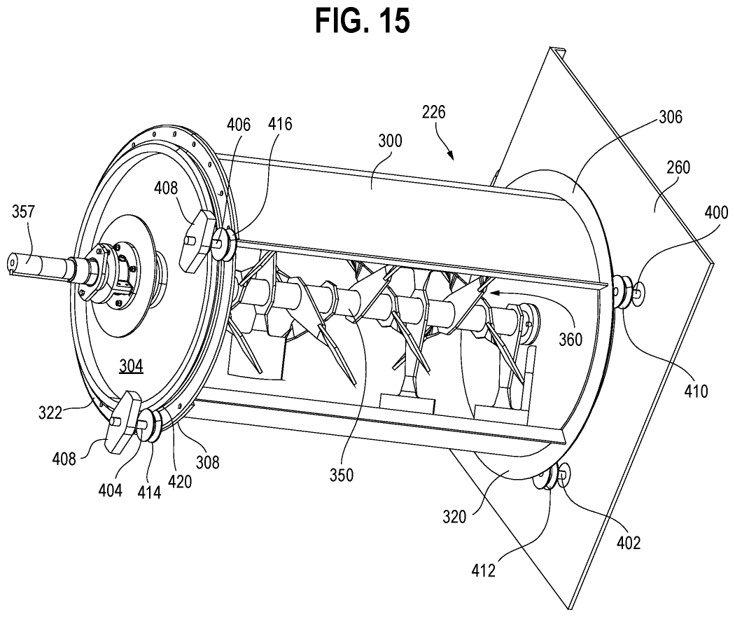

FIGS. 10-15 illustrate a further embodiment of a mixer 226 that may be used in lieu of the mixer 26 in the system 20. The mixer 226 is similar or identical to the mixer 26 except as indicated hereinbelow, and corresponding structures of the mixer 26 and the mixer 226 are assigned reference numbers that differ by 200.

The mixer 226 comprises a main housing 240 similar or identical to the main housing 40 and an inner mixing drum 300, with one exception being that the inner mixing drum 300 includes an end wall 304 and a further end wall 305 at an opposite end of the mixing drum 300. The main housing 240 and the end walls 304 and 305 of the inner mixing drum 300 are journaled at ends 355, 357 of a shaft 350 of an agitator 360. The inner mixing drum 300 is thus capable of independent relative rotation with respect to the main housing 240. Also, the shaft 350 can independently rotate within the main housing 240 and further is independently rotatable with respect to the inner mixing drum 300. The apparatus that affords this independent movement comprises any suitable device or devices known to one of ordinary skill in the art (e.g., roller or ball bearing devices or the like). The partial rings 120, 122 are replaced by full rings 320, 322 that are secured to ends 306, 308 of the inner mixing drum 300 and/or to the end walls 304 and 305 and first and second pairs of spaced stub shafts 400, 402 and 404, 406 are secured by suitable fasteners 408 to end plates 260, 262, respectively, of the main housing 240. Bearing-mounted casters or rollers 410, 412, 414, 416 are rotatably mounted on inner ends of the stub shafts 400, 402, 404, 406, respectively, and rotatably support axially outwardly extending flanges 418, 420 of the full rings 320, 322, respectively. The casters 410, 412, 414, 416 assist in supporting the inner mixing drum 300. A shaft 424 of a gear 426 is rotatably mounted on the end plate 305. The gear 426 includes teeth that mesh with inwardly extending teeth of a ring gear 428 comprising a part of the full ring 322. As the gear 426 is rotated the ring gear 428, and thus the inner mixing drum 300, which is fastened securely to the ring gear 428, are rotated.

A plurality of fluid dispensing nozzles 299 are carried by and extend through portions of the side plates 264, 266. In the preferred embodiment, the nozzles 299 are mounted in the arcuate central portions 284, 294, although one or more of the nozzles may be mounted in another portion or portions of the main housing 240. The nozzles 299 are coupled to a controllable pressurized water (and, optionally, air) source 301.

The mixer 226 is assembled in a fashion similar to the method of assembling the mixer 26, with the added steps of securing the stub shafts 400, 402, 404, 406 and associated casters 410, 412, 414, 416 to the end plates 260, 262 at appropriate points in the assembly sequence. As in the previous embodiment, an end plate 262 is preferably (although not necessarily) removably fastened by bolts or other fasteners to the end 308 of the inner mixing drum so that the end plate 262 can be readily removed for servicing and/or cleaning.

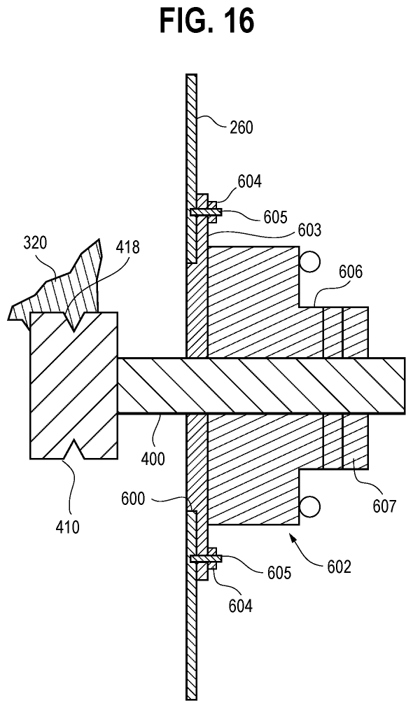

If necessary or desirable, assembly may be facilitated by providing four enlarged recesses 600 in the end plates 260, 262 as seen in FIG. 16, wherein each recess 600 receives a mounting assembly 602 having a spacer plate 603 that, in turn, carries one of the stub shafts 400-406 and associated casters 410-416, such as the illustrated stub shaft 400 and the associated caster 410. Each spacer plate 603 is secured by suitable fasteners 604, such as nuts and lock washers, to threaded studs 605 welded or otherwise secured at spaced portions of the respective end plate 260, 262. A bearing 606 is retained by a shaft collar 607 and surrounds the stub shaft 400-406 and permits the stub shaft 400-406 to rotate relative to the respective end plate 260, 262. In the illustrated embodiment, and unlike the previous embodiment described immediately above, the associated caster 410-416 rotates with the stub shaft 400-406, although the caster 410-416 may be rotatable relative to the associated stub shaft 400-406, in which case the stub shaft may be fixed (i.e., not rotatable) relative to the end plate 260, 262. In any event, each mounting assembly 602 may be assembled with one of the stub shafts 400-406 and associated caster 410-416 and inserted through the respective enlarged recess 600 and secured to the respective end plate 260, 262 with the casters 410-416 in contact with the flanges 418, 420.

### INDUSTRIAL APPLICABILITY

Referring again to FIGS. 2-5 and 7-9, once the mixer 26 is assembled as described above, the first spindle 161 of the agitator 160 is mechanically coupled to a first motor 190 (FIG. 2) and the second spindle 182 of the agitator 160 is mechanically coupled to a second motor 192. The spindles 161 and 182 may be coaxial and are relatively rotatable using any interconnection scheme known to one of skill in the art. The spindles 161 and 182 are rigidly secured to and rotatable with a blade assembly 194 of the agitator 160 and the disk-shaped end wall 104, respectively.

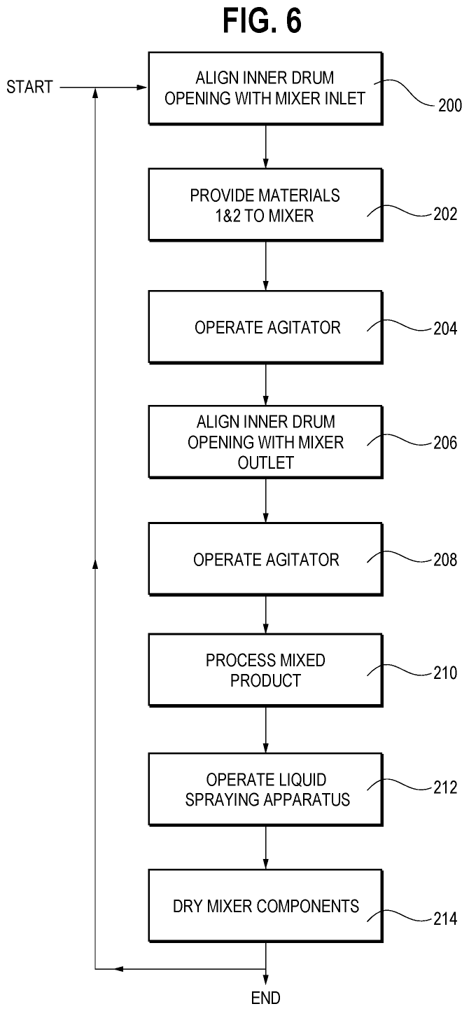

Referring also to FIG. 6, at a step 200 the mixer 26 is prepared for use by operating the first motor 190 to align the opening 110 of the inner mixing drum 100 with the inlet 42 of the mixer 26. At least first and second materials are loaded into the mixer 26 through the inlet 42 at a step 202 and the second motor 192 is actuated at a step 204 to mix the materials. The opening 110 may be maintained by the first motor 190 in the position aligned with the inlet 42 during mixing or the opening 110 may be moved to another position closing off the opening 110 from the inlet 42 and the outlet 46. Once the mixing operation is complete, the first motor 190 is operated at a step 206 to align the opening 110 with the outlet 46 (otherwise referred to as positioning the opening 110 at the discharge position). Discharge of the mixed materials may then take place, optionally assisted by operation of the agitator 160 by the second motor 191 (step 208) to help ensure that all or substantially all materials are removed from the mixer 26.

Following a mixing and material discharge operation as described above processing of the mixed product as noted previously is effected at a step 210. During the step 208 or thereafter, a cleaning operation may be undertaken at a step 212. In one embodiment, a cleaning operation is undertaken when the opening 110 is disposed at the discharge position or at any other position. A cleaning fluid, such as water and/or pressurized air and/or another liquid, is introduced by the fluid source 101 through the nozzles 99 into and about the inner mixing drum 100. In a specific embodiment, water is sprayed through the nozzles 99 as the inner mixing drum 100 is moved by the motor 190 through several full rotations, although the water may be sprayed while the inner mixing drum 100 is moved through a sequence of fixed positions and/or while the inner drum is held at a fixed position. The liquid(s) are sprayed for a duration of a spray cycle, which may be a fixed duration or which may be for a variable duration dependent upon the amount of cleaning that is considered necessary or desirable. Following an end of the spray cycle, an optional drying cycle may be undertaken at a step 214. The drying cycle may simply be a fixed or variable period of time that elapses following a spray cycle during which the components of the mixer 26 air-dry. Alternatively or in addition, the drying cycle may comprise a fixed or variable period of time during which compressed and/or heated air is directed toward the components of the mixer 26, optionally through one or more of the nozzles 99, to accomplish forced drying. In still another embodiment, a first drying sub-cycle may be undertaken during which forced drying is undertaken followed by a second drying sub-cycle during which air-drying is allowed to occur. In any event, cleaning and/or drying cycles are optional procedures that may or may not be considered necessary or desirable. In particular, it may not be necessary or desirable to clean the mixer 26 between mixing batches, or it might necessary or desirable to clean the mixer 26 only between certain mixing batches.

Following the step 214, further mixing of other material batches may be undertaken, in which case the steps 200-214 are repeated, or mixing is terminated.

Referring to FIGS. 10-16, in like fashion the mixer 226 can be used in the steps 200-214. In such embodiment, motors 390, 391 are coupled to the gear 426 and the shaft 350, respectively, and are operated to rotate the inner mixing drum 300 and the agitator 360, respectively, as shown in FIG. 6 and described previously. Cleaning can be undertaken as described in connection with the previous embodiment.

The mixer 26 or 226 is easily cleaned between batches or uses as necessary or desirable to minimize/eliminate cross-contamination. Further, the mixer 26 or 226 is readily partially or fully disassembled to permit recovery of mixed product so as to maximize revenue and/or to further facilitate cleaning. These beneficial results are realized, at least in part, by the provision of cleaning device(s) in the form of the liquid spraying apparatus and/or by securing the end plate 62 or 262 (and, possibly, other parts of the mixer 26 or 226, such as the end plate 305) to other portions of the mixer 26 or 226 by bolts or other readily removable fasteners that can be removed in the field to expose the inner portions of the mixer 26 or 226.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. It should be understood that the illustrated embodiments are exemplary only, and should not be taken as limiting the scope of the disclosure.

We claim:

1. 1. A method of producing a product having mixed constituents, the method comprising the steps of;
providing a mixing apparatus including a main housing having an inlet and an outlet opposite the inlet wherein the outlet is disposed at a lower portion of the main housing, a mixing drum disposed in the main housing wherein the mixing drum includes an opening that is movable between a first position aligned with the inlet and a second position aligned with the outlet, and an agitator disposed inside the mixing drum;
providing first and second materials;
positioning the mixing drum at the first position;
introducing the first and second materials into the mixing drum through the aligned opening and inlet;
operating the agitator to mix the first and second materials to produce a human-edible product;
moving the mixing drum to the second position; and
removing the human-edible product from the mixing drum through the aligned opening and outlet.

2. The method of claim 1, comprising the further step of spraying a liquid into the mixing drum during or after the step of removing the mixed first and second materials from the mixing drum.

3. The method of claim 1, comprising the further step of operating a sprayer to spray water into the mixing drum during or after the step of removing the mixed materials from the mixing drum.

4. The method of claim 1, wherein the step of removing the mixed first and second materials comprises the step of operating the agitator.

5. The method of claim 1, wherein the step of operating the agitator comprises the step of agitating the first and second materials while the opening is aligned with the inlet.

6. The method of claim 1, wherein the step of positioning the mixing drum comprises the step of operating a motor to rotate the mixing drum.

7. The method of claim 1, wherein the step of operating the agitator comprises the step of operating a motor to rotate the agitator.

8. The method of claim 1, wherein the step of positioning the mixing drum comprises the step of operating a motor to rotate the mixing drum and the step of operating the agitator comprises the step of operating the motor to rotate the agitator.

9. The method of claim 1, further including the step of packaging the human edible product after removal thereof from the mixing drum.

10. A method of producing a product having mixed constituents, the method comprising the steps of;
a. providing a mixing apparatus including a main housing having an inlet and an outlet opposite the inlet wherein the outlet is disposed at a lower portion of the main housing, a mixing drum disposed in the main housing wherein the mixing drum includes an opening that is movable between a first position aligned with the inlet and a second position aligned with the outlet, a liquid spraying apparatus, and an agitator disposed inside the mixing drum;
b. providing a first batch of first and second materials;
c. positioning the mixing drum at the first position;
d. introducing the first and second materials into the mixing drum through the aligned opening and inlet;
e. operating the agitator to mix the first and second materials to produce a human-edible product;
f. moving the mixing drum to the second position;
g. removing the human-edible product from the mixing drum through the aligned opening and outlet;
h. operating the liquid spraying apparatus to spray a liquid toward at least one of the mixing drum and the outlet;
i. drying the liquid;
j. providing a second batch of the first and second materials; and
k. repeating steps c.-i. for the second batch of the first and second materials.

11. The method of claim 1, wherein the step h. comprises the step of spraying water.

12. The method of claim 1, comprising the further step of processing the first and second batches.

13. The method of claim 1, wherein the step g. comprises the step of operating the agitator.

14. The method of claim 1, wherein the step e. comprises the step of agitating the first and second materials while the opening is aligned with the inlet.

15. The method of claim 1, wherein the step c. comprises the step of operating a motor to rotate the mixing drum.

16. The method of claim 1, wherein the step e. comprises the step of operating a motor to rotate the agitator.

17. The method of claim 1, wherein the step c. comprises the step of operating a motor to rotate the mixing drum and the step e. comprises the step of operating the motor to rotate the agitator.

18. A mixing apparatus, comprising:
a main housing having an inlet and an outlet opposite the inlet wherein the outlet is disposed at a lower portion of the main housing;
a mixing drum disposed in the main housing wherein the mixing drum is disposed inside the main housing and includes an opening that is movable between a first position aligned with the inlet and a second position aligned with the outlet and further having a non-apertured side wall terminating at side edges of the opening;
an agitator disposed inside the mixing drum; and
a motor that moves the mixing drum between the first and second positions.

19. The mixing apparatus of claim 18, further including a sprayer mounted to the main housing for spraying a cleaning fluid toward the outlet.

20. The mixing apparatus of claim 19, further including a sprayer for spraying water toward at least one of the outlet and the opening.
